(19) United States
(12) Patent Application Publication
(10) Pub. No.: US 2023/0095913 A1
(43) Pub. Date: Mar. 30, 2023

(54) BALL MOUNT HITCH ASSEMBLY WITH RETRACTABLE HITCH PINS

(71) Applicant: HitchLocker LLC, Bernie, MO (US)

(72) Inventor: Gene Slinkard, Bernie, MO (US)

(21) Appl. No.: 17/935,454

(22) Filed: Sep. 26, 2022

Related U.S. Application Data
(60) Provisional application No. 63/360,341, filed on Sep. 27, 2021.

(51) Int. Cl. B60D 1/54; B60D 1/06

(52) U.S. Cl. CPC B60D 1/54; B60D 1/06

(57) ABSTRACT

A hitch assembly includes a tubular shank, a tongue, at least one hitch ball, and a pin retractor assembly. The shank extends longitudinally from a first to second end. The shank also defines a pair of through holes. The pin retractor assembly includes a pull plate and a pin assembly. The pull plate is moveable in a longitudinal direction between a first position and a second position. The pin assembly includes at least two engagement pins operatively coupled to the pull plate. Each engagement pin is moveable in a direction perpendicular to the longitudinal direction between an extended position, in which each engagement pin protrudes through a corresponding one of the pair of through holes defined by the shank, and a retracted position. Actuation of the pull plate from the first position to the second position causes the engagement pins to move from the extended position to the retracted position.

### CROSS-REFERENCE TO RELATED APPLICATIONS

This application claims priority to U.S. Provisional Patent Application No. 63/360,341, filed Sep. 27, 2021, the disclosure of which is hereby incorporated by reference in its entirety.

### FIELD OF THE DISCLOSURE

The field of the disclosure relates generally to hitch assemblies and, more specifically, to ball mount hitch assemblies that include retractable hitch pins.

### BACKGROUND

Hitch assemblies are commonly used to attach a trailer to a towing vehicle via a ball that is mounted on the hitch assembly. When a hitch assembly is attached to a towing vehicle, the hitch assembly is traditionally mounted inside a hollow shank installed on the vehicle and secured to the vehicle via a hitch pin. Traditional hitch assemblies require manual installation of a separate hitch pin to secure the hitch assembly to the vehicle, and the separate hitch pin has the potential to be lost when it is not being used. The installation and removal of traditional hitch pins can be a burdensome process, requiring users to manually manipulate the pins. This can also make the hitch pins weaker and more prone to failure during use, for example, due to bending or twisting of the hitch pin after multiple installations and removals.

### BRIEF SUMMARY

In one aspect, a hitch assembly includes a tubular shank, a tongue coupled to the tubular shank, at least one hitch ball coupled to the tongue, and a pin retractor assembly. The shank extends longitudinally from a first end to a second end and defines an elongate passage extending between the first end and the second end. The shank also defines a pair of through holes. The pin retractor assembly includes a pull plate and a pin assembly. The pull plate is accessible from outside the shank and is moveable in a longitudinal direction between a first position and a second position. The pin assembly includes at least two engagement pins operatively coupled to the pull plate. Each engagement pin is moveable in a direction perpendicular to the longitudinal direction between an extended position, in which each engagement pin protrudes through a corresponding one of the pair of through holes defined by the shank, and a retracted position. Actuation of the pull plate from the first position to the second position causes the engagement pins to move from the extended position to the retracted position.

In another aspect, a hitch assembly includes a tubular shank, a tongue, at least one hitch ball coupled to the tongue, and a pin retractor assembly. The tubular shank extends longitudinally from a first end to a second end and defines an elongate passage extending between the first end and the second end. The shank also defines a pair of through holes. The tongue includes at least one through hole. The first end of the shank is coupled to the tongue. The pin retractor assembly includes a pull plate, a rod coupled to the pull plate, a cam plate operatively coupled to the pull plate, and a pin assembly. The pull plate is accessible from outside the shank and is moveable in a longitudinal direction between a first position and a second position. The rod extends through the at least one through hole of the tongue and is moveable within the elongate passage when the pull plate is actuated between the first position and the second position. The cam plate includes a base defining at least two cam slots. The pin assembly includes at least two engagement pins that are each moveable in a direction perpendicular to the longitudinal direction between an extended position and a retracted position. Each engagement pin includes a guide pin extending from the engagement pin and into a corresponding one of the cam slots. Actuation of the pull plate from the first position to the second position causes the cam plate to move in the longitudinal direction such that the cam plate engages the guide pins within the cam slots, causing the guide pins to move laterally inward and the engagement pins to move from the extended position to the retracted position.

In yet another aspect, a method of assembling a hitch assembly includes providing a tubular shank coupled to a tongue and at least one hitch ball coupled to the tongue. The shank extends longitudinally from a first end to a second end and defines an elongate passage extending between the first end and the second end. The shank also defines a pair of through holes. The method also includes positioning an engagement pin within each of the pair of through holes of the shank such that each engagement pin is moveable in a direction perpendicular to the longitudinal direction between an extended position, in which each engagement pin protrudes through a corresponding one of the pair of through holes defined by the shank, and a retracted position, and operatively coupling the engagement pins to a pull plate that is accessible from outside the shank and moveable in a longitudinal direction between a first position and a second position. Actuation of the pull plate from the first position to the second position causes the engagement pins to move from the extended position to the retracted position.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of an example hitch assembly with retractable hitch pins, illustrated in an extended position.

FIG. 2 is a schematic side view of the hitch assembly of FIG. 1 connected to a vehicle.

FIG. 3 is a top view of the hitch assembly of FIG. 1.

FIG. 4 is a side view of the hitch assembly of FIG. 1.

FIG. 5 is a sectional view of the hitch assembly of FIG. 3, taken along line 5-5.

FIG. 6 is a sectional view of the hitch assembly of FIG. 4, taken along line 6-6.

FIG. 7 is an enlarged view of the hitch assembly of FIG. 5.

FIG. 8 is a front view of the hitch assembly of FIG. 1.

FIG. 9 is a rear view of the hitch assembly of FIG. 1.

FIG. 10 is a bottom view of a cam plate, an end plate, and a pin assembly of the hitch assembly of FIG. 1.

FIG. 11 is a perspective view of the cam plate of FIG. 10.

FIG. 12 is a front view of the pin assembly of FIG. 10.

FIG. 13 is a bottom view of the pin assembly of FIG. 10.

FIG. 14 is a sectional view of the pin assembly of FIG. 13, taken along line 14-14.

FIG. 15 is a side view of the hitch assembly of FIG. 1, with the shank omitted to illustrate internal features.

FIG. 16 is a top view of the hitch assembly of FIG. 15.

FIG. 17 is a perspective view of the hitch assembly of FIG. 1, with the retractable hitch pins illustrated in a retracted position.

FIG. 18 is a top view of the hitch assembly of FIG. 17.

FIG. 19 is a side view of the hitch assembly of FIG. 17.

FIG. 20 is a sectional view of the hitch assembly of FIG. 18, taken along line 20-20.

FIG. 21 is a sectional view of the hitch assembly of FIG. 19, taken along line 21-21.

FIG. 22 is a bottom view of the cam plate, the end plate, and the pin assembly of the hitch assembly of FIG. 17.

FIG. 23 is a side view of the hitch assembly of FIG. 17, with the shank omitted to illustrate internal features.

FIG. 24 is a top view of the hitch assembly of FIG. 23.

FIG. 25 is a perspective view of a second example hitch assembly with retractable hitch pins, illustrated in an extended position.

FIG. 26 is a perspective view of the hitch assembly of FIG. 25 with an alternative locking or retaining component.

FIG. 27 is a perspective view of the hitch assembly of FIG. 25 with the retractable hitch pins illustrated in a retracted position.

FIG. 28 is a perspective view of a third example hitch assembly with retractable hitch pins, illustrated in an extended position.

FIG. 29 is a perspective view of the hitch assembly of FIG. 28, with the retractable hitch pins illustrated in a retracted position.

### DETAILED DESCRIPTION

Embodiments of the hitch assemblies described herein facilitate improved installation and removal of the hitch assemblies on a vehicle. For example, embodiments of the hitch assemblies described herein include a pin retractor assembly that includes retractable hitch or engagement pins that retract when a pull plate is actuated. The retractable engagement pins and easily accessible pull plate facilitate ease of installing and removing the hitch assembly from a vehicle.

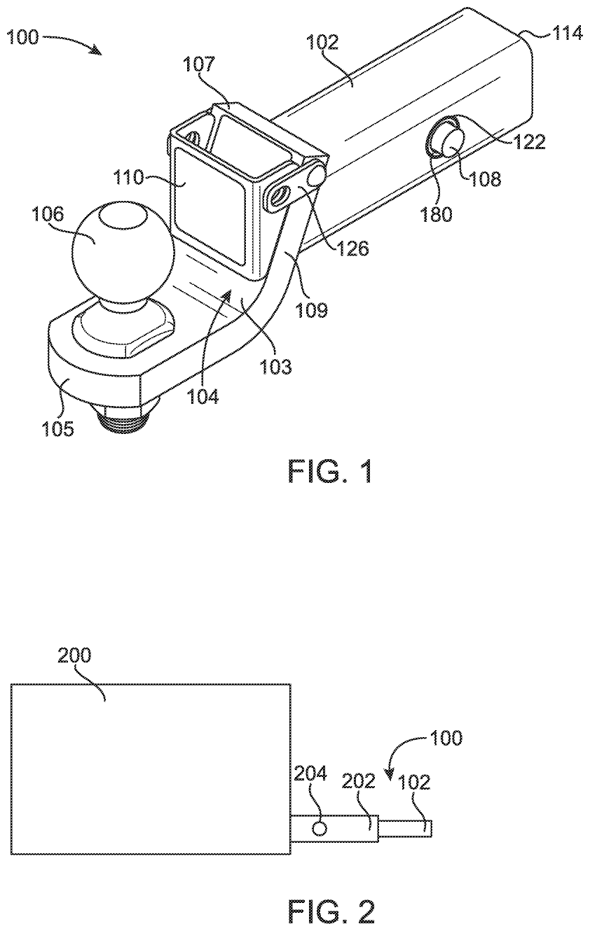

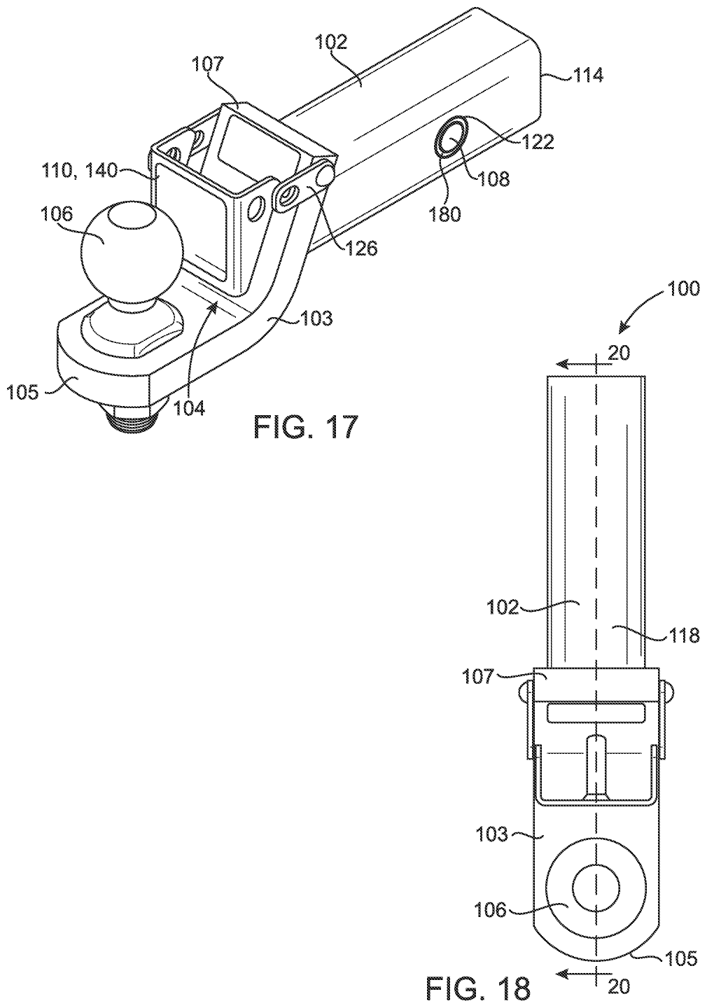

FIG. 1 is a perspective view of an example hitch assembly 100 with hitch or engagement pins 108 illustrated in an extended position. The hitch assembly 100 includes a shank 102, a tongue 103, a pin retractor assembly 104, and at least one hitch ball 106. The pin retractor assembly 104 includes engagement pins 108 (only one engagement pin is shown in FIG. 1), and is operable to move the engagement pins 108 between an extended position (shown in FIG. 1) and a retracted position (shown in FIG. 17). That is, the pin retractor assembly 104 is operable to retract the engagement pins 108 into the shank 102.

FIG. 2 is a schematic side view of the hitch assembly 100 installed on a vehicle 200. As shown in FIG. 2, to install or connect the hitch assembly 100 to a vehicle 200, the shank 102 of the hitch assembly 100 (with the engagement pins 108 retracted) is inserted into a receiver tube 202 attached to the vehicle 200 until the engagement pins 108 of the hitch assembly 100 are aligned with through holes 204 of the receiver tube 202. In FIG. 2, only one through hole 204 of the receiver tube 202 is shown, although the receiver tube 202 includes a second through hole 204 on the opposite side of the receiver tube 202. Once the engagement pins 108 of the hitch assembly 100 are aligned with the through holes 204 of the receiver tube 202, the engagement pins 108 are actuated to the extended position such that the engagement pins 108 extend through the through holes 204 of the receiver tube 202 to secure the hitch assembly 100 to the vehicle 200.

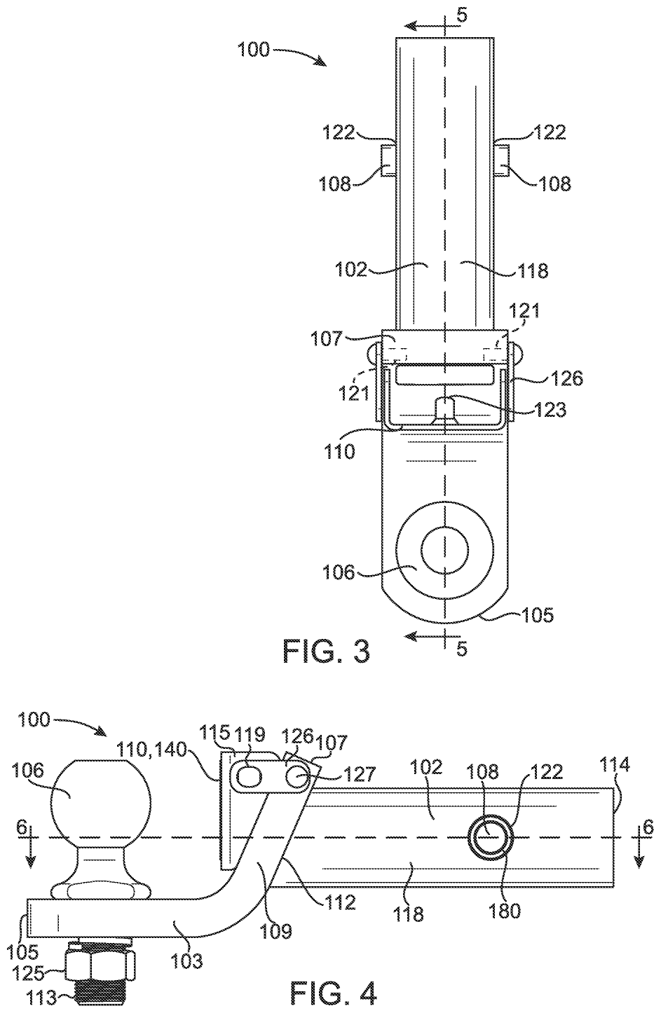

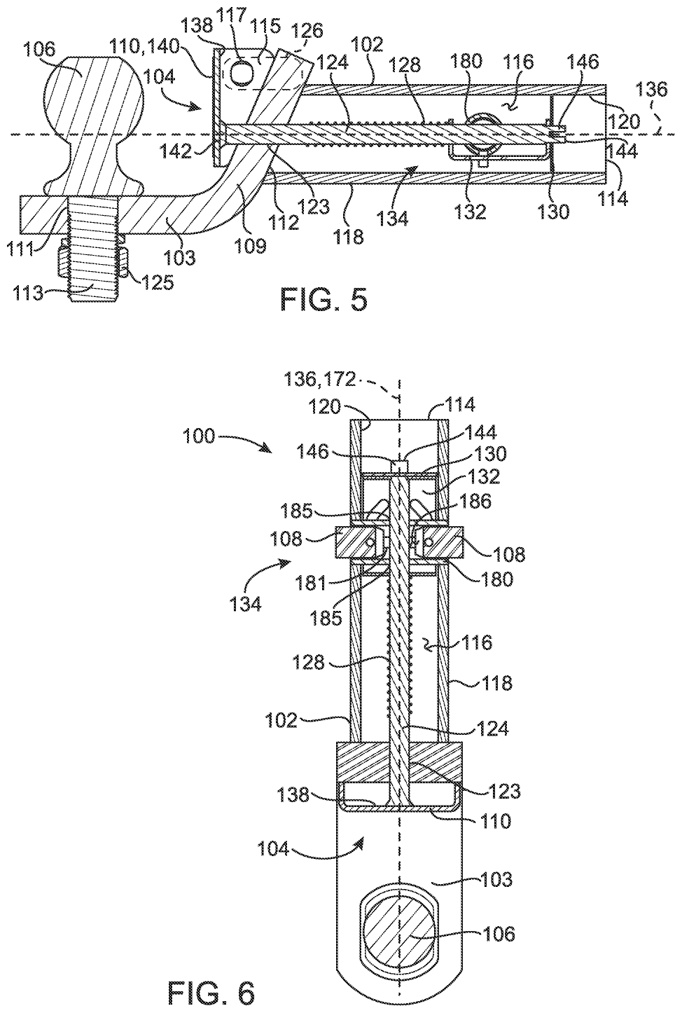

With additional reference to FIGS. 3-6, 15, and 16, the shank 102 of the hitch assembly 100 is tubular and extends longitudinally from a first end 112 to a second end 114. The shank 102 defines an elongate passage 116 (shown in FIGS. 5-7) that extends between the first end 112 and the second end 114. The shank 102 includes an exterior surface 118 and an interior surface 120. The shank 102 defines a pair of coaxial through holes 122 through which the engagement pins 108 extend. That is, the through holes 122 of the shank 102 are aligned with the engagement pins 108 such that each of the engagement pins 108 can slide within a respective one of the through holes 122. The shank 102 can be constructed of, for example and without limitation, steel, stainless steel, mild or low carbon steel, and combinations thereof. In other embodiments, the shank 102 may be of any suitable configuration and may have any suitable number of through holes 122 that enables hitch assembly 100 to function as described herein.

The hitch assembly 100 also includes a tongue 103 coupled to the shank 102. The tongue 103 extends from a first end 105 to a second end 107 and includes a slanted portion 109. In the exemplary embodiment, the first end 112 of the shank 102 is coupled to the slanted portion 109 of the tongue 103. That is, the first end 112 of the shank 102 is slanted relative to the second end 114 of the shank 102 such that the first end 112 of the shank 102 can be coupled to the slanted portion 109 of the tongue 103. The shank 102 may be coupled to the tongue by, for example and without limitation, welding, fasteners, and combinations thereof. The tongue 103 further includes at least one through hole 111 (shown in FIG. 5) that is operable to receive, for example, a shank of a hitch ball 106. The tongue 103 also includes a pair of recesses 121 (shown in FIG. 3) that are each operable to receive a fastener therein. In the example embodiment, the two recesses 121 are formed in opposing side surfaces of the tongue 103. In other embodiments, the tongue 103 may alternatively include a single through hole in place of the two recesses 121. The tongue 103 further includes a through hole 123 that is operable to receive a rod (e.g., rod 124) therein. In the example embodiment, the through hole 123 is located within the slanted portion 109 of the tongue 103. In other embodiments, the shank 102 may be of any suitable configuration and may have any suitable number of holes 111, recesses 121, or through holes 123 having any suitable configuration that enables the hitch assembly 100 to function as described herein.

As shown in FIGS. 1 and 3-5, the hitch assembly 100 includes one or more hitch balls 106 coupled to the tongue 103. In the illustrated embodiment, the hitch assembly 100 is a single ball mount hitch assembly including one hitch ball 106 mounted to a first side of the tongue 103. In other embodiments, the shank 102 may include more than one hitch ball, such as two hitch balls coupled to the tongue 103 in any suitable configuration that enables the hitch assembly 100 to function as described herein.

In the illustrated embodiment, the hitch ball 106 is removably coupled to the tongue 103 by a threaded shank 113 and a corresponding nut 125. Specifically, the threaded shank 113 is received within the through hole 111 of the tongue 103, and the nut 125 is coupled to the threaded shank 113 on a side of the tongue 103 opposite the hitch ball 106. In other embodiments, the hitch ball 106 may be permanently coupled to the tongue 103 using other coupling techniques, such as welding.

With reference to FIGS. 1, 3-7, 15, and 16, the pin retractor assembly 104 of the example embodiment includes a pull plate 110, at least one locking bracket 126, a rod 124, a spring 128, an end plate 130, a cam plate 132, and a pin assembly 134.

The pull plate 110 is accessible from outside the shank 102 and is moveable along a longitudinal axis 136 of the shank 102 between a first position (shown in FIGS. 1, 5, and 6) and a second position (shown in FIG. 17). The pull plate 110 includes an inner surface 138 (shown in FIG. 5) that faces the slanted portion 109 of the tongue 103, and an outer surface 140 that is opposite to the inner surface 138 and faces away from the slanted portion 109. The pull plate 110 also includes a pair of locking flanges 115 that each include a through hole 117. Each locking flange 115 respectively extends from an opposing side of the pull plate 110. In the exemplary embodiment, the pull plate 110 is sized in order to have clearance around adjacent components (e.g., the tongue 103) and is generally square or rectangular, with triangular locking flanges 115. However, the pull plate 110 may be of any suitable size and/or configuration that enables the hitch assembly 100 to function as described herein.

The pin retractor assembly 104 further includes at least one locking bracket 126 fixedly coupled to the tongue 103. As shown in FIG. 4, each locking bracket 126 is substantially rectangular in shape and includes two through holes 119 (one through hole has a fastener 127 installed therein and is occluded from view). Each locking bracket 126 is connected to the tongue 103 via the fastener 127 inserted though one of the through holes 119 in each locking bracket 126, and into one of the recesses 121 (shown in FIG. 3) in the tongue 103. In some embodiments, the locking brackets 126 can be permanently coupled to the tongue 103 by, for example and without limitation, fasteners, welding, and combinations thereof.

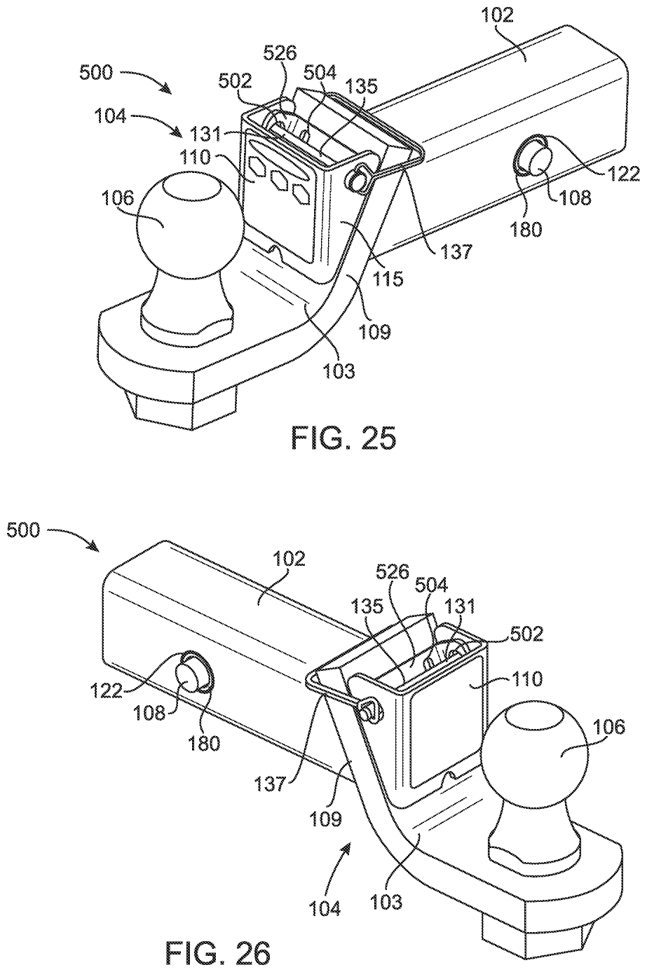

The locking flanges 115 of the pull plate 110 and the at least one locking bracket 126 are configured to lock the pull plate 110 in the first position via insertion of a locking or retaining component into the through holes 117, 119 of both the locking flanges 115 and the at least one locking bracket 126, respectively. That is, the through holes 117 of the locking flanges 115 of the pull plate 110 and one through hole 119 in each locking bracket 126 are aligned when the pull plate 110 is in the first position, and can be used to secure and/or inhibit movement of the pull plate 110, thereby inhibiting movement of the engagement pins 108. For example, after the hitch assembly 100 is installed on a vehicle 200, a locking or retaining rod or pin (e.g., the shank or shackle of a lock) can be inserted in one of the through holes 119 in each locking bracket 126 and the through holes 117 of the locking flanges 115 of the pull plate 110 to prevent the pull plate 110 from moving out of the first position. Thus, when a locking or retaining rod or pin is inserted into one of the through holes 119 in each locking bracket 126 and the through holes 117 of the locking flanges 115 of the pull plate 110 while the hitch assembly 100 is installed on a vehicle 200, the hitch assembly 100 cannot be removed from the vehicle 200 unless the locking or retaining rod or pin is first removed from one of the through holes 119 in each locking bracket 126 and the through holes 117 of the locking flanges 115 of the pull plate 110. The through holes 119 in each locking bracket 126 and the through holes 117 of the locking flanges 115 of the pull plate 110 thereby enhance the safety of the hitch assembly 100 by helping prevent unwanted removal of the hitch assembly 100 during use, and also help prevent theft of the hitch assembly 100 while the hitch assembly 100 is installed on a vehicle 200. FIG. 25 illustrates a second embodiment of the hitch assembly 100 of FIG. 1, and includes a locking or retaining component 131 locking the pull plate 110 in the first position as described above.

Moving the pull plate 110 from the first position to the second position actuates the pin retractor assembly 104 to retract the engagement pins 108 from the extended position (shown in FIGS. 1 and 3-6) to the retracted position (shown in FIG. 17). In the retracted position, the engagement pins 108 are generally flush with or recessed from the exterior surface 118 of the shank 102 such that the hitch assembly 100 can be freely inserted into or removed from a receiver tube of a vehicle (e.g., receiver tube 202) without obstruction from the engagement pins 108. The pull plate 110 is biased toward the first position by the spring 128 such that, when the pull plate 110 is released (e.g., by a user), the pin retractor assembly 104 automatically returns the pull plate 110 to the first position, and also returns the engagement pins 108 to the extended position.

As shown in FIGS. 5-7, 15, and 16, the rod 124 extends from a first end 142 connected to the pull plate 110 to a second end 144 positioned opposite the first end 142. The rod 124 is partially enclosed by the shank 102 and passes through the through hole 123 in the tongue 103. The first end 142 of the rod 124 is coupled to the inner surface 138 of the pull plate 110. The second end 144 of the rod 124 includes fins 146 that are operable to couple the second end 144 of the rod 124 to the end plate 130, as described further herein. In the exemplary embodiment, the rod 124 includes two fins 146. In other embodiments, the rod 124 may include any suitable number of fins 146 that enables the hitch assembly 100 function as described herein.

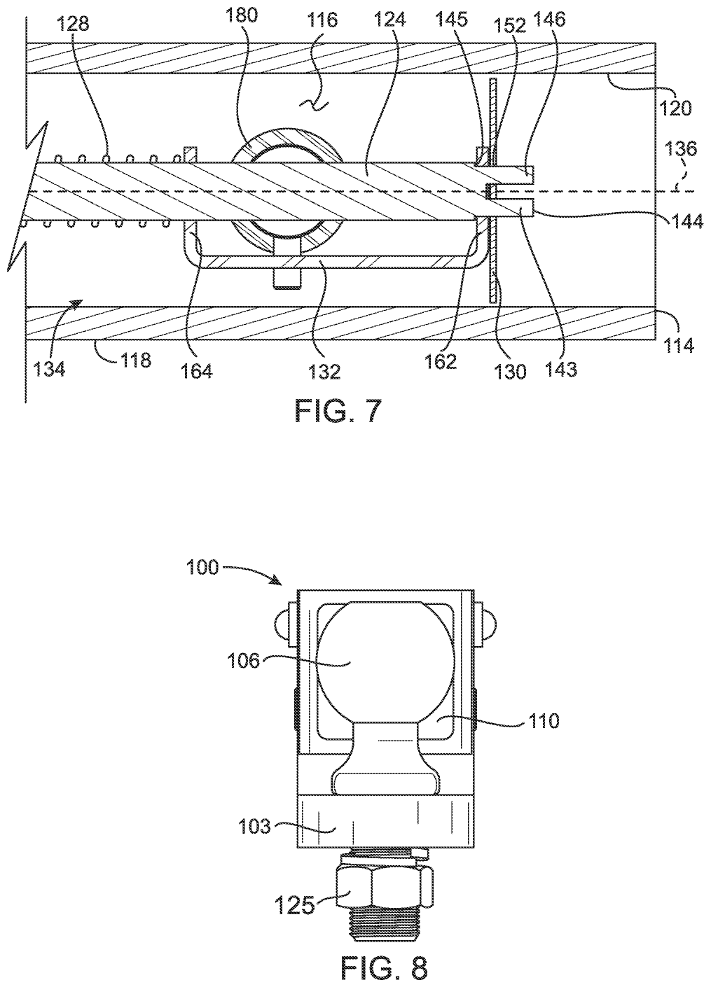

In the illustrated embodiment, the second end 144 of the rod 124 includes a reduced-diameter portion 143 (shown in FIG. 7) having a diameter less than the adjacent portion of the rod 124. The reduced-diameter portion 143 of the rod 124 extends from a radially-extending flange 145 (shown in FIG. 7) of the rod 124 to the second end 144 of the rod 124. As described further herein, the radially-extending flange 145 functions as a stop surface to facilitate securing the cam plate 132 to the rod 124.

The rod 124 is moveable within the elongate passage 116 of the shank 102 upon actuation of the pull plate 110. More specifically, when the pull plate 110 is actuated between the first position and the second position, the rod 124 moves longitudinally with the pull plate 110. As shown in FIGS. 5-7, 15, and 16, the rod 124 is of a general cylindrical shape. However, the rod 124 may be of any suitable configuration that enables the hitch assembly 100 to function as described herein.

As shown in FIGS. 5, 6, 15, and 16, the slanted portion 109 of the tongue 103 is generally positioned between the pull plate 110 and the first end 112 of the shank 102. The tongue 103 is configured to support the rod 124 as it translates within the passage 116 upon actuation of the pull plate 110, and is also configured to function as a spring stop for the spring 128. The tongue 103 is fixed to the shank 102 such that the tongue 103 remains stationary when the pull plate 110 and rod 124 are actuated. As shown in FIGS. 5 and 6, the rod 124 extends through the through hole 123 of the tongue 103. That is, the through hole 123 of the tongue 103 is aligned with the rod 124 and sized such that the rod 124 can move therein.

The spring 128 is disposed between the tongue 103 and the cam plate 132, and biases the pull plate 110 toward the slanted portion 109 of the tongue 103 and toward the first position such that, in the absence of an applied force, the pull plate 110 moves toward the slanted portion 109 of the tongue 103 to the first position under the force of the spring 128. That is, the spring 128 biases the cam plate 132 away from the tongue 103, thereby biasing the pull plate 110 toward the first position. In the illustrated embodiment, the spring 128 is wound around the rod 124, and is coupled directly to the cam plate 132, specifically by engaging a flange of the cam plate 132 (e.g., flange 160 of the cam plate 132, described further herein). In other embodiments, the spring 128 may be operatively coupled to the pull plate 110 to bias the pull plate 110 toward the first position using any suitable coupling. In the exemplary embodiment, the spring 128 is a coil compression spring. However, the spring 128 may be any suitable spring or biasing device that enables the hitch assembly 100 to function as described herein.

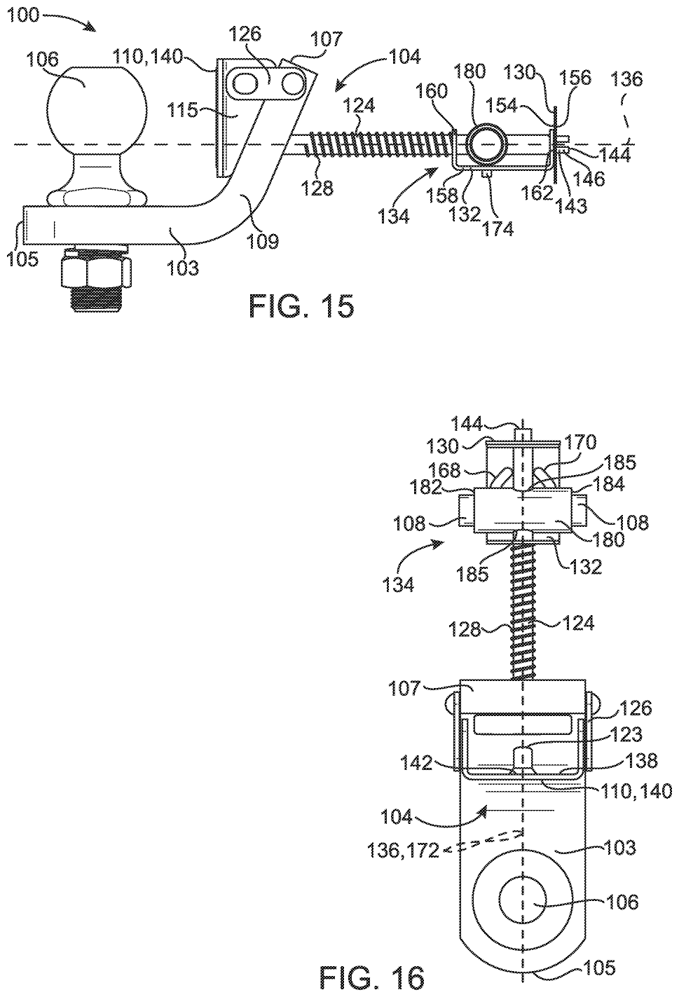

The end plate 130 is coupled to the second end 144 of the rod and includes at least one through hole 152 (FIG. 7). The end plate 130 includes an inner surface 154 (shown in FIG. 15) that faces the tongue 103 and an outer surface 156 (shown in FIG. 15) that faces the opposite direction. In the exemplary embodiment, the end plate 130 is not fixed or secured to the interior surface 120 of the shank 102, and moves or translates within the elongate passage 116 with movement of the rod 124. In the exemplary embodiment, the end plate 130 includes two through holes 152 that receive the two fins 146 of the rod 124. In one example embodiment, to assemble the pin retractor assembly 104, the fins 146 are inserted through the through holes 152 of the end plate 130, and are bent (e.g., away from one another) to prevent the end plate 130 from sliding off the second end 144 of the rod 124.

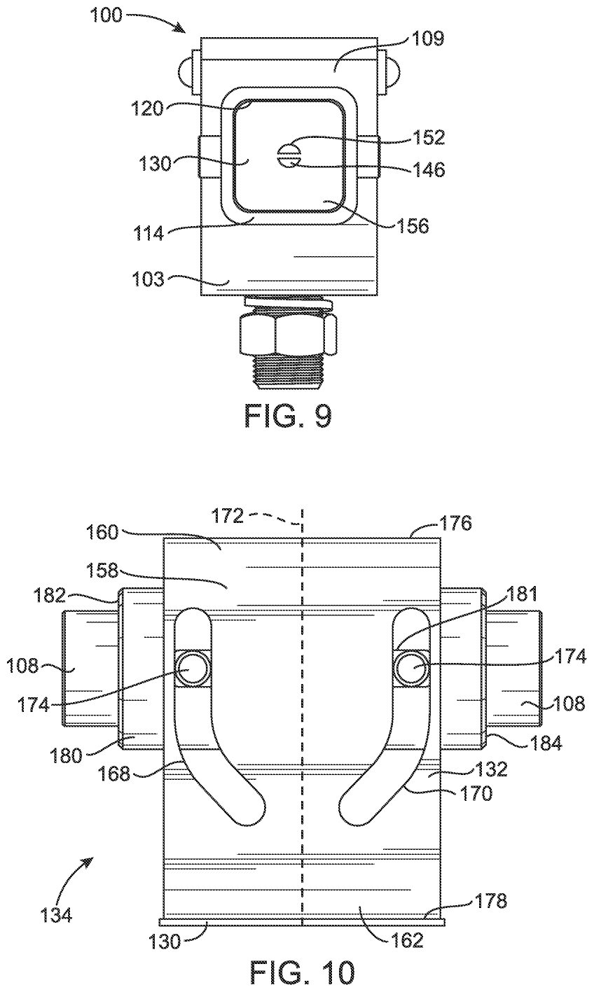

With reference to FIG. 9, the fins 146 have a general semi-circular shape with a rectangular notch or gap defined between the fins 146 in the exemplary embodiment. In other embodiments, the fins 146 may have any suitable configuration that enables the hitch assembly 100 to function as described herein.

With additional reference to FIGS. 7 and 15, the cam plate 132 is positioned in engagement with the end plate 130 at the inner surface 154 of the end plate 130 such that the end plate 130 is sandwiched between the cam plate 132 and the fins 146 of the rod 124 (e.g., when the fins 146 are bent). The end plate 130 is thereby coupled to the rod 124, and moves or translates with the rod 124 upon actuation of the pull plate 110.

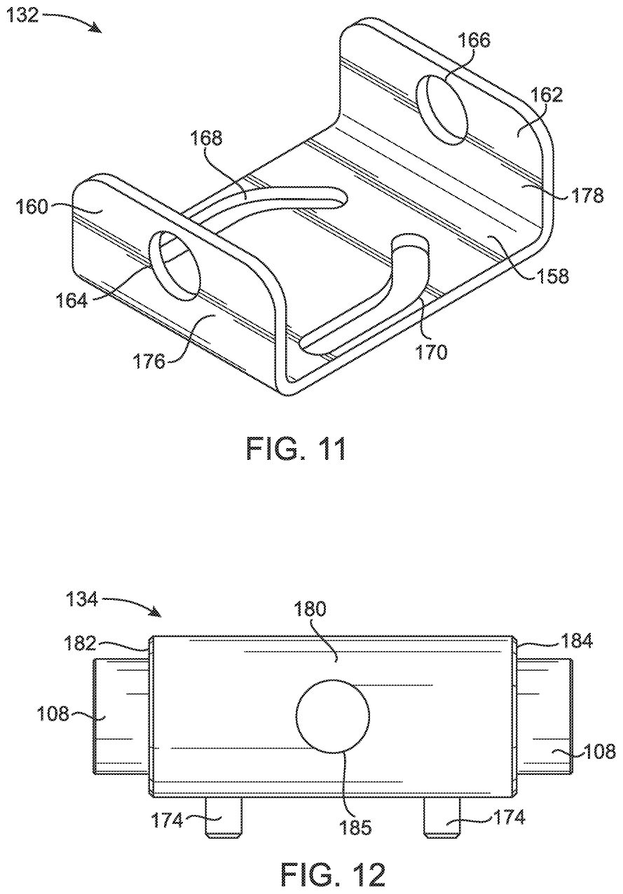

The cam plate 132 is also operatively coupled to the pull plate 110, and is configured to move the engagement pins 108 between the extended position and the retracted position upon actuation of the pull plate 110. As shown in FIGS. 10 and 11, the cam plate 132 includes a base 158, a first flange 160 extending from the base 158 at a first end 176 of the cam plate 132, and a second flange 162 extending from the base 158 at a second, opposite end 178 of the cam plate 132. As shown in FIG. 11, each of the first flange 160 and the second flange 162 is oriented perpendicular to the base 158 in the illustrated embodiment. Additionally, the first flange 160 and the second flange 162 include respective through holes 164, 166 through which the rod 124 extends.

In the illustrated embodiment, the through hole 166 of the second flange 162 has a smaller diameter than the through hole 164 of the first flange 160. The reduced diameter of the through hole 166 of the second flange 162 is sized and shaped to receive the reduced-diameter portion 143 of the rod 124, and also facilitates preventing incorrect installation of the cam plate 132 on the rod 124 during assembly. Moreover, the larger-diameter through hole 164 is sized and shaped to receive the rod 124 therein, and the through hole 166 is sized and shaped such that the second flange 162 engages the radially-extending flange 145 of the rod 124 to inhibit the rod 124 from passing through the through hole 166.

As described above, in one example embodiment, to assemble the pin retractor assembly 104, the fins 146 of the rod 124 are inserted through the through holes 152 of the end plate 130, and are bent (e.g., away from one another) to prevent the end plate 130 from sliding off the second end 144 of the rod 124. When the fins 146 of the rod 124 are bent away from each other, the fins 146 also force or bias the end plate 130 against the cam plate 132, thereby compressing the cam plate 132 between the end plate 130 and the radially-extending flange 145 of the rod 124 and securing the cam plate 132 to the rod 124.

As shown in FIGS. 10 and 11, the base 158 of the cam plate 132 defines two cam slots 168, 170 that are generally symmetrical about a central longitudinal axis 172 of the cam plate 132. Each of the cam slots 168, 170 is configured (e.g., sized and shaped) to receive a respective guide pin 174 of the pin assembly 134, as described further herein. Each of the cam slots 168, 170 has a generally constant width along its length, and includes a first, linear section oriented parallel to the longitudinal axis 172, and a second section oriented at an oblique angle relative to the first section and the longitudinal axis 172. As shown in FIG. 10, the cam slots 168, 170 are laterally closer together nearer to the second end 178 of the cam plate 132 and are laterally farther apart nearer to the first end 176 of the cam plate 132. That is, relative to the hitch assembly 100 (as shown in FIG. 6), the cam slots 168, 170 are laterally farther apart nearer to the tongue 103, and are laterally farther apart further from the tongue 103. In other embodiments, the cam slots 168, 170 may have any suitable configuration that enables the hitch assembly 100 to function as described herein. As described further herein, translation of the cam plate 132 relative to guide pins 174 in the longitudinal direction (i.e., a direction parallel to the longitudinal axes 136 and 172) causes the guide pins 174 to move laterally inward and outward due to engagement between the guide pins 174 and the cam plate 132 within the cam slots 168, 170. This lateral movement of the guide pins 174, in turn, causes movement of the engagement pins 108 between the extended and retracted positions.

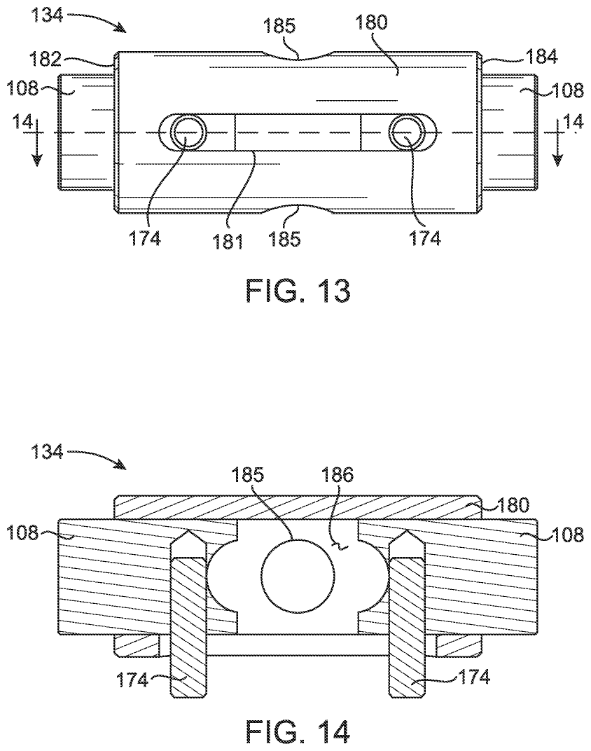

With additional reference to FIGS. 12 and 13, the pin assembly 134 includes a sleeve 180 and at least two engagement pins 108. In the exemplary embodiment, the pin assembly 134 includes two engagement pins 108. Although other embodiments may include a different number of engagement pins 108. Additionally, as shown in FIGS. 5, 7, and 10, the pin assembly 134 is mounted in the through holes 122 of the shank 102 between the first flange 160 and the second flange 162 of the cam plate 132. Each engagement pin is moveable in a direction perpendicular to the longitudinal direction between the extended position, in which each engagement pin 108 protrudes through a corresponding one of the pair of through holes 122 defined by the shank 102, and the retracted position. The at least two engagement pins 108 of the pin assembly 134 are operatively coupled to the pull plate 110 such that actuation of the pull plate 110 from the first position to the second position causes the engagement pins 108 to move from the extended position to the retracted position.

With reference to FIGS. 6, 7, and 10, the sleeve 180 is disposed within the elongate passage 116 of the shank 102. The sleeve 180 extends from a first end 182 to a second end 184, and defines a passage 186 (shown in FIGS. 6 and 14) that is oriented perpendicular to the elongate passage 116 of the shank 102 and aligned with each of the through holes 122 defined by the shank 102.

As shown in FIGS. 1, 4, and 6, the sleeve 180 is mounted in the pair of through holes 122 defined by the shank 102. In the exemplary embodiment, the sleeve 180 is free-floating (i.e., the sleeve itself is not fixed), but is restrained from moving in the longitudinal direction via the through holes 122 of the shank 102. The sleeve 180 is further restrained from moving laterally (i.e., perpendicular to the longitudinal direction) via the rod 124 and the end plate 130. In some embodiments, the sleeve 180 may move laterally within the elongate passage 116 of the shank 102 in accordance with (i) clearance between the rod 124 and the through hole 123 of the tongue 103 and/or (ii) clearance between lateral sides of the end plate 130 and the interior surface 120 of the shank 102.

As shown in FIGS. 6, 10, and 13, the sleeve 180 defines an elongate sleeve slot 181 oriented perpendicular to the longitudinal axes 136 and 172. The sleeve 180 further defines a pair of through holes 185 through which the rod 124 extends when the hitch assembly 100 is assembled. That is, the through holes 185 of the sleeve 180 are aligned with the rod 124 and sized such that the rod 124 can move freely therethrough.

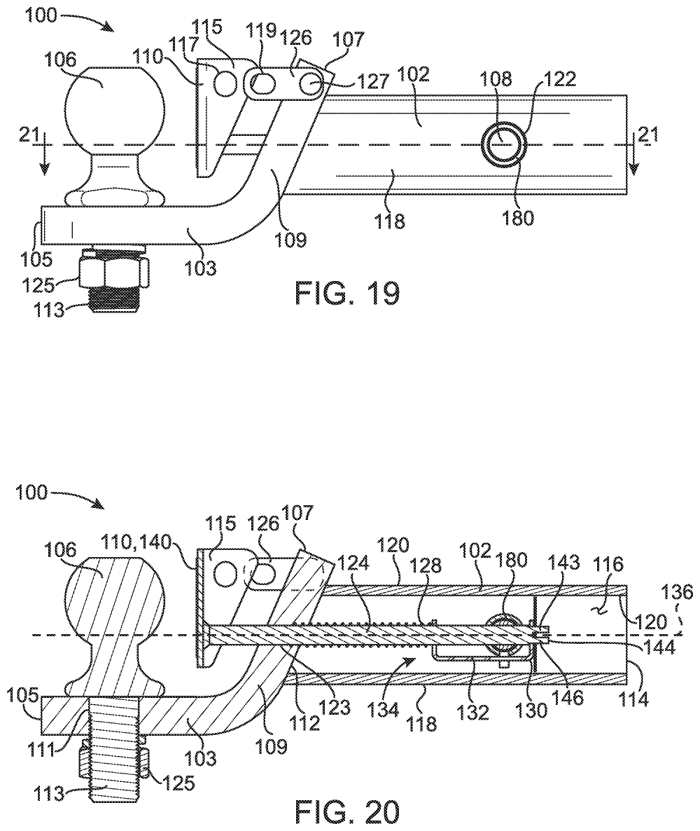

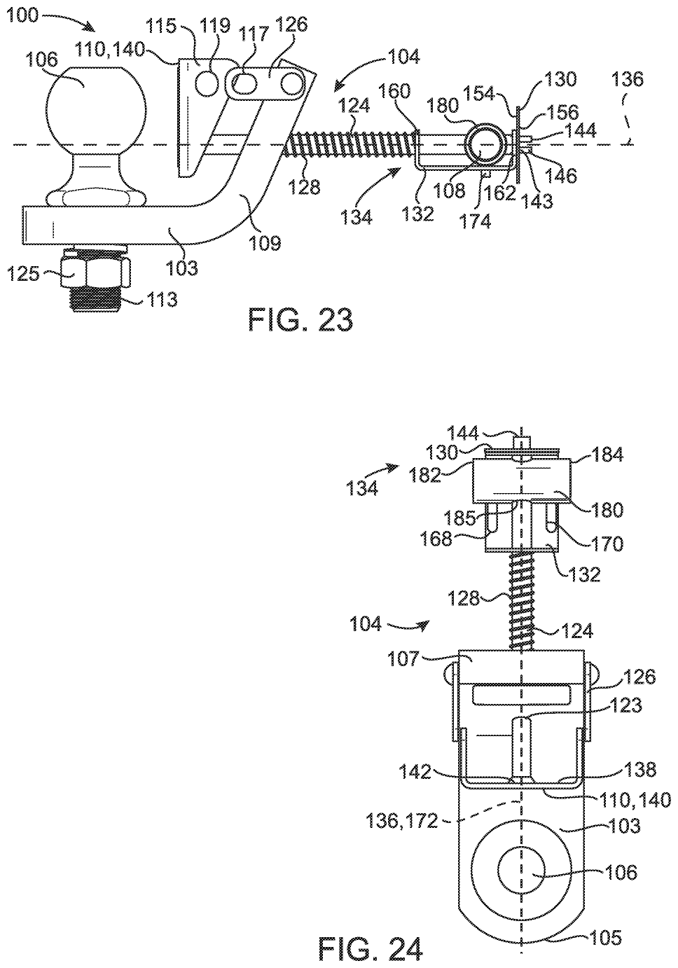

The engagement pins 108 are disposed, at least partially, within the sleeve passage 186 (shown in FIG. 14), and are movable in a direction perpendicular to the longitudinal axes 136 and 172 between the extended position and the retracted position. In the extended position (shown in FIGS. 1, 3-10, and 12-16), the engagement pins 108 protrude through a respective one of the first end 182 and the second end 184 of the sleeve 180 and a corresponding one of the pair of through holes 122 defined by the shank 102. In the retracted position (shown in FIGS. 17-24), the engagement pins 108 are retracted at least partially within the sleeve passage 186. In the exemplary embodiment, the engagement pins 108 are generally cylindrical. Additionally, as shown in FIGS. 6 and 14, the lateral inner side of each engagement pin 108 is shaped to accommodate the shape of the rod 124 that passes through the sleeve 180. More specifically, each engagement pin 108 has a semi-circular cutout formed in the lateral inner side thereof to accommodate the cylindrical rod 124. In other embodiments, the engagement pins 108 may have any suitable configuration that enables the hitch assembly 100 to function as described herein.

With reference to FIGS. 10 and 12-14, each engagement pin 108 includes at least one guide pin 174 that extends from the engagement pin 108, through the sleeve slot 181 (shown in FIG. 13) and into a corresponding one of the cam slots 168, 170 of the cam plate 132. In the exemplary embodiment, the pin assembly 134 includes two guide pins 174, and the guide pins 174 are generally cylindrical. However, the pin assembly 134 may include any suitable number of guide pins 174, and the guide pins 174 may have any suitable configuration that enables the hitch assembly 100 to function as described herein.

In use, actuation of the pull plate 110 from the first position to the second position causes the rod 124 and the cam plate 132 to move in the longitudinal direction. The cam plate 132 engages the guide pins 174 within the cam slots 168, 170, causing the guide pins 174 to move laterally inward in the sleeve slot 181 (i.e., toward the longitudinal axis 136 as shown in FIG. 6) and the engagement pins 108 to move from the extended position to the retracted position as the cam plate 132 moves toward the first end 112 of the shank 102 (or the slanted portion 109 of the tongue 103).

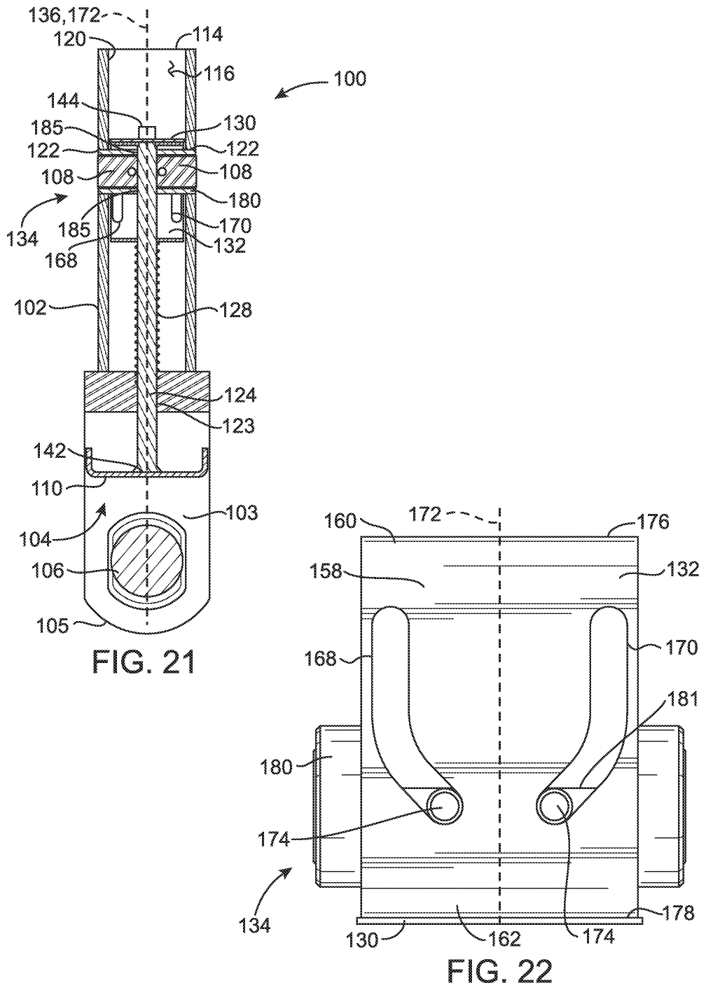

As shown in FIGS. 17, 18, and 21, when the pull plate 110 is actuated from the first position to the second position, the engagement pins 108 are moved from the extended position to the retracted position. As shown in FIGS. 17 and 21, in the retracted position, the engagement pins 108 are retracted at least partially into the sleeve passage 186 such that the engagement pins 108 are flush with or recessed from the exterior surface 118 of the shank 102. In some embodiments, the engagement pins 108 may be further retracted into the sleeve passage 186 such that the engagement pins 108 are substantially enclosed by the elongate passage 116 of the shank 102.

As shown in FIGS. 20, 21, 23, and 24, when the pull plate 110 is actuated to the second position, the rod 124 moves in a corresponding manner along the longitudinal axis 136. As the rod 124 moves along the longitudinal axis 136, the end plate 130 and the cam plate 132 also move in a corresponding manner along the longitudinal axis 136. That is, when the pull plate 110 is actuated to move toward the second position, the pull plate 110, the rod 124, the end plate 130, and the cam plate 132 all move in a corresponding manner toward the first end 112 of the shank 102 (or toward the slanted portion 109 of the tongue 103) in the longitudinal direction.

As described above, the sleeve 180 is mounted in the pair of through holes 122 defined by the shank 102. In the exemplary embodiment, the sleeve 180 is free-floating, but is restrained from excess longitudinal or lateral movement by other components. In some embodiments, the sleeve 180 may move laterally within the elongate passage 116 of the shank 102 in accordance with (i) clearance between the rod 124 and the through hole 123 of the tongue 103 and/or (ii) clearance between lateral sides of the end plate 130 and the interior surface 120 of the shank 102. Therefore, when the pull plate 110 is actuated toward the second position, the sleeve 180 may move in accordance with the surrounding structure. In other embodiments, the sleeve 180 may move any amount in any direction so long as the hitch assembly 100 is enabled to function as described herein.

As the cam plate 132 moves toward the first end 112 of the shank 102, the cam slots 168, 170 also move toward the first end 112 of the shank 102. As the cam slots 168, 170 move toward the first end 112 of the shank 102, the guide pins 174 remain engaged with the cam slots 168, 170. As described above, the cam slots 168, 170 are laterally closer together nearer to the second end 178 of the cam plate 132 and are laterally farther apart nearer to the first end 176 of the cam plate 132. Accordingly, as the pull plate 110 is actuated toward the second position, the portions of the cam slots 168, 170 that are engaged by the guide pins 174 move laterally closer together (shown in FIG. 22), and therefore the guide pins 174 and the engagement pins 108 move laterally closer together (i.e., toward the longitudinal axis 136 as shown in FIG. 21 or toward the central longitudinal axis 172 of the cam plate 132 as shown in FIG. 22). In other words, as the pull plate 110 is actuated toward the second position, the engagement pins 108 are retracted at least partially into the sleeve passage 186.

With reference to FIG. 2, during installation, a user actuates the pull plate 110 such that that pull plate 110 moves from the first position to the second position and the engagement pins 108 are correspondingly moved into the retracted position. With the engagement pins 108 in the retracted position, the user inserts the shank 102 of the hitch assembly 100 into the receiver tube 202 of the vehicle 200 until the engagement pins 108 are aligned with the through holes 204 of the receiver tube 202. Once the engagement pins 108 are aligned with the through holes 204 in the receiver tube 202, the user releases the pull plate 110, and the spring 128 moves the pull plate 110 back to the first position, which causes the engagement pins 108 to move into the extended position. When the engagement pins 108 are moved into the extended position, the engagement pins 108 extend through the through holes 204 of the receiver tube 202, thereby securing the hitch assembly 100 to the vehicle 200. The hitch assembly 100 can be removed from the vehicle 200 by retracting the engagement pins 108 (via actuation of the pull plate 110, as described above), and removing the hitch assembly 100 from the receiver tube 202. With the hitch assembly 100 installed on the vehicle 200, a locking or retaining rod or pin can be inserted into one of the through holes 119 in each locking bracket 126 and the through holes 117 of the locking flanges 115 of the pull plate 110, thereby locking the hitch assembly 100 to the vehicle 200.

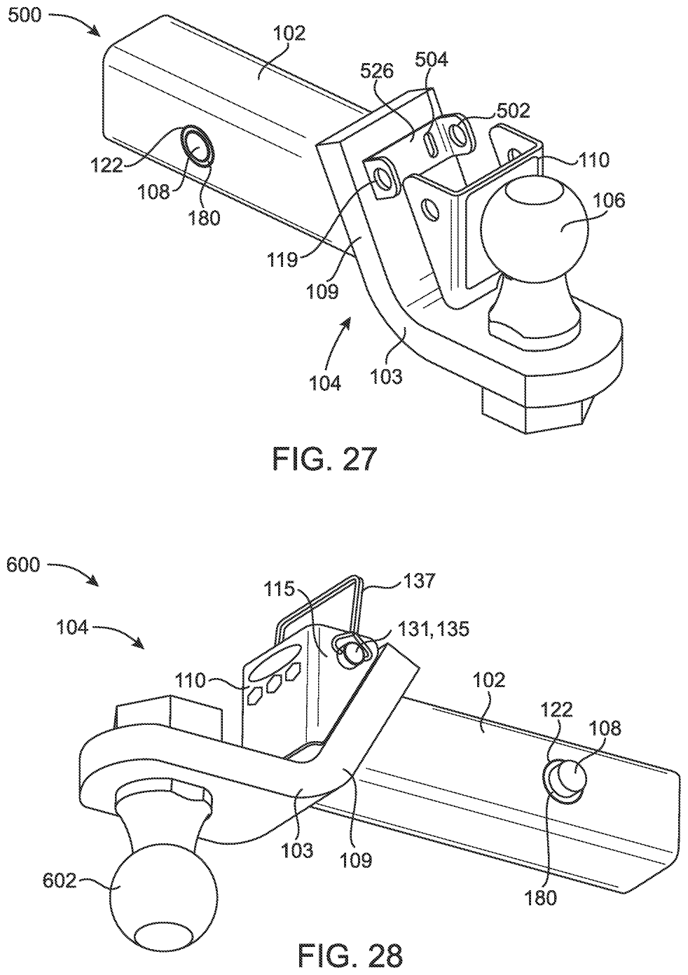

FIGS. 25-27 illustrate a second exemplary hitch assembly 500. The hitch assembly 500 is similar to the hitch assembly 100 described herein, except for the configuration of locking bracket 126 (referred to as locking bracket 526 with respect to the hitch assembly 500). Components of hitch assembly 500 include identical numbering to similar components of the hitch assembly 100, with different components (e.g., locking bracket 526) including different reference numbers. For example, the pull plate of the hitch assembly 500 and the pull plate 110 of the hitch assembly 100 are similar, and therefore the pull plate of the hitch assembly 500 will be referenced as pull plate 110.

As shown in FIGS. 25-27, the hitch assembly 500 includes one locking bracket 526 including through holes 502 and through holes 504 and is coupled to a medial portion of the tongue 103 between the locking flanges 115 of the pull plate 110. The locking bracket 526 of the hitch assembly 500 may be coupled to the tongue 103 via, for example, fasteners (via through holes 504) or welding. Further, FIGS. 25 and 26 illustrate two different embodiments of locking or retaining components 131. In both FIGS. 25 and 26, the locking or retaining component 131 includes a pin 135 that is locked in place by a wire 137. Specifically, the pin 135 is inserted through the through holes 119 of the locking flanges 115 of the pull plate 110 and also through the though holes 502 of the locking bracket 526 to lock the pull plate 110 in the first position. The pin 135 is secured to the hitch assembly 500 via the wire 137.

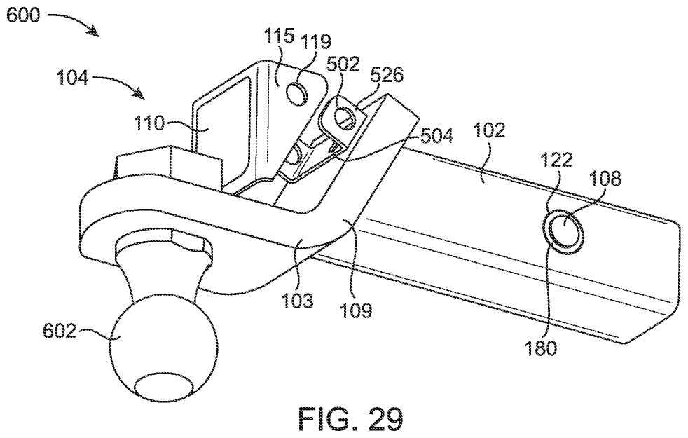

FIGS. 28 and 29 illustrate a third exemplary hitch assembly 600. The hitch assembly 600 is similar to the hitch assembly 500 described herein, except that hitch assembly 600 includes one hitch ball 602 coupled to a second side of the tongue 103. Components of hitch assembly 600 include identical numbering to similar components of the hitch assembly 100 and the hitch assembly 500, with different components (e.g., hitch ball 602) including different reference numbers.

The hitch assemblies 500, 600 function similarly to the hitch assembly 100 to extend and retract the engagement pins 108. That is, actuation of the pull plate 110 from the first position to the second position causes the engagement pins 108 to move from the extended position to the retracted position. Further, when the pull plate 110 is released (e.g., by a user) while out of the first position, the pin retractor assembly 104 automatically returns the pull plate 110 to the first position, and also returns the engagement pins 108 to the extended position.

The present disclosure provides at least the following technical benefits and advantages: (i) ease and efficiency of installation and removal of hitch assemblies from vehicles, (ii) fewer components required for installation of hitch assemblies on vehicles (e.g., no separate hitch pin), (iii) reduction of user mistakes when installing the hitch assembly on a vehicle, and (iv) enhanced safety of using the hitch assembly due to decreased risk of the hitch pin being inadvertently removed from the installed hitch assembly during use.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A hitch assembly comprising:
a tubular shank extending longitudinally from a first end to a second end and defining an elongate passage extending between the first end and the second end, the shank defining a pair of through holes;
a tongue coupled to the tubular shank;
at least one hitch ball coupled to the tongue; and
a pin retractor assembly comprising:
a pull plate accessible from outside the shank and moveable in a longitudinal direction between a first position and a second position; and
a pin assembly comprising at least two engagement pins operatively coupled to the pull plate, wherein each engagement pin is moveable in a direction perpendicular to the longitudinal direction between an extended position, in which each engagement pin protrudes through a corresponding one of the pair of through holes defined by the shank, and a retracted position,
wherein actuation of the pull plate from the first position to the second position causes the engagement pins to move from the extended position to the retracted position.

2. The hitch assembly of claim 1, wherein the pin retractor assembly further comprises a rod coupled to the pull plate and moveable within the elongate passage when the pull plate is actuated between the first position and the second position.

3. The hitch assembly of claim 1, wherein the pin retractor assembly further comprises a spring operatively coupled to the pull plate to bias the pull plate toward the first position.

4. The hitch assembly of claim 1, wherein the tongue comprises a slanted portion, wherein the first end of the shank is coupled to the slanted portion of the tongue.

5. The hitch assembly of claim 1, wherein the pin retractor assembly further comprises a cam plate operatively coupled to the pull plate, wherein the cam plate comprises a base defining at least two cam slots.

6. The hitch assembly of claim 5, wherein the pin retractor assembly further comprises a spring coupled to the cam plate and disposed between the tongue and the cam plate, wherein the spring biases the cam plate away from the tongue, thereby biasing the pull plate toward the first position.

7. The hitch assembly of claim 5, wherein the cam plate comprises two flanges, each extending from the base, wherein the pin assembly is mounted in the through holes of the shank between the two flanges of the cam plate.

8. The hitch assembly of claim 5, wherein the cam plate comprises two cam slots, wherein the cam slots are symmetric about a longitudinal axis of the shank, and wherein the cam slots are closer together further from the tongue.

9. The hitch assembly of claim 5, wherein each engagement pin comprises a guide pin extending from the engagement pin and into a corresponding one of the cam slots, and wherein actuation of the pull plate from the first position to the second position causes the cam plate to move in the longitudinal direction such that the cam plate engages the guide pins within the cam slots, causing the guide pins to move laterally inward and the engagement pins to move from the extended position to the retracted position.

10. The hitch assembly of claim 1, wherein the pin assembly further comprises a sleeve disposed within the elongate passage, the sleeve defining a passage oriented perpendicular to the elongate passage of the shank, wherein the at least two engagement pins are disposed at least partially within the passage of the sleeve.

11. The hitch assembly of claim 1, wherein the pin retractor assembly further comprises:
at least one locking bracket coupled to the tongue and including at least one through hole,
wherein the pull plate comprises at least one locking flange including at least one through hole;
wherein the at least one locking flange of the pull plate and the at least one locking bracket are configured to lock the pull plate in the first position via insertion of a locking component into the through holes of both the at least one locking flange and the at least one locking bracket.

12. A hitch assembly comprising:
a tubular shank extending longitudinally from a first end to a second end and defining an elongate passage extending between the first end and the second end, the shank defining a pair of through holes;
a tongue including at least one through hole, the first end of the shank coupled to the tongue;
at least one hitch ball coupled to the tongue; and
a pin retractor assembly comprising:
a pull plate accessible from outside the shank and moveable in a longitudinal direction between a first position and a second position;
a rod coupled to the pull plate, the rod extending through the at least one through hole of the tongue and moveable within the elongate passage when the pull plate is actuated between the first position and the second position;
a cam plate operatively coupled to the pull plate, wherein the cam plate comprises a base defining at least two cam slots; and
a pin assembly comprising at least two engagement pins, each moveable in a direction perpendicular to the longitudinal direction between an extended position and a retracted position, each engagement pin comprising a guide pin extending from the engagement pin and into a corresponding one of the cam slots,
wherein actuation of the pull plate from the first position to the second position causes the cam plate to move in the longitudinal direction such that the cam plate engages the guide pins within the cam slots, causing the guide pins to move laterally inward and the engagement pins to move from the extended position to the retracted position.

13. The hitch assembly of claim 12, wherein the pin retractor assembly further comprises a spring operatively coupled to the pull plate to bias the pull plate toward the first position.

14. The hitch assembly of claim 12, wherein the tongue further comprises a slanted portion, wherein the first end of the shank is coupled to the slanted portion of the tongue.

15. The hitch assembly of claim 12, wherein the cam plate further comprises at least one flange extending from the base and defining a through hole, wherein the rod extends through the through hole of the at least one flange.

16. The hitch assembly of claim 12, wherein the pin retractor assembly further comprises:
at least one locking bracket coupled to the tongue and including at least one through hole,
wherein the pull plate comprises at least one locking flange including at least one through hole;
wherein the at least one locking flange of the pull plate and the at least one locking bracket are configured to lock the pull plate in the first position via insertion of a locking component into the through holes of both the at least one locking flange and the at least one locking bracket.

17. A method of assembling a hitch assembly, said method comprising:
providing a tubular shank coupled to a tongue and at least one hitch ball coupled to the tongue, wherein the shank extends longitudinally from a first end to a second end and defines an elongate passage extending between the first end and the second end, wherein the shank defines a pair of through holes;
positioning an engagement pin within each of the pair of through holes of the shank such that each engagement pin is moveable in a direction perpendicular to a longitudinal direction between an extended position, in which each engagement pin protrudes through a corresponding one of the pair of through holes defined by the shank, and a retracted position; and
operatively coupling the engagement pins to a pull plate that is accessible from outside the shank and moveable in the longitudinal direction between a first position and a second position, wherein actuation of the pull plate from the first position to the second position causes the engagement pins to move from the extended position to the retracted position.

18. The method of claim 17, wherein operatively coupling the engagement pins to the pull plate comprises coupling a rod to the pull plate such that the rod is moveable within the elongate passage when the pull plate is actuated between the first position and the second position.

19. The method of claim 17 further comprising operatively coupling a spring to the pull plate to bias the pull plate toward the first position.

20. The method of claim 17, wherein operatively coupling the engagement pins to the pull plate comprises operatively coupling a cam plate to the pull plate.
